(19) United States
(12) Patent Application Publication
(10) Pub. No.: US 2003/0140082 A1
(43) Pub. Date: Jul. 24, 2003

(54) Patch processing system and method

(75) Inventor: Tatsuya Hase, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/347,762

(22) Filed: Jan. 22, 2003

(30) Foreign Application Priority Data
Jan. 23, 2002 (JP) 2002-014496

(51) Int. Cl. G06F 9/44; G06F 9/00

(52) U.S. Cl. 709/102; 717/168

(57) ABSTRACT

In parallel-running multi-task system, a patch file is structured so that first, second, third and fourth programs are loaded onto a memory when the patch file is read from the storage device. Multiple application tasks are placed under exclusive control so that a target task is prevented from being accessed from other tasks. The operation of the target task is stopped if the first program is detected, and a patch is applied to the target task. The target task is restarted if the second program is detected, and the exclusive control is removed. Exclusive control is further placed over the tasks so that the patched task is prevented from being accessed from other tasks. The operation of the patched task is stopped if the third program is detected and an undo process is performed on the patched task, which is then restarted if the fourth program is detected and the exclusive control is removed.

### BACKGROUND OF THE INVENTION

1. Field of the Invention

The present invention relates generally to multi-task computer systems, and more specifically to a patch processing system.

2. Description of the Related Art

A patch is a piece of code that represents a programmer's afterthought, is generated by more primitive means that was the program it is to be applied to, and is usually overwritten on code or data in the program to be patched.

Japanese Patent Publication 60-75936 discloses a patch system in which the original machine language program is saved in a separate processor when a patch is applied, so that the patched program can be restored. Japanese Patent Publication 61-199150 relates to a multi-task computer system in which the system is prevented from being restarted by disabling a communication adaptor in response to a patch request. The processor is interrupted to activate a patch startup routine to save the patch data in a firmware storage memory. When the patch request is removed, an end-of-patch interrupt routine begins and the communication adaptor is restarted.

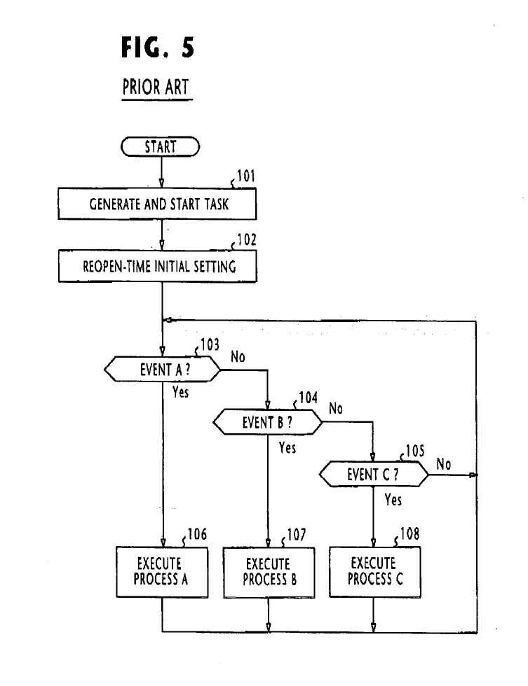

In a prior art resident task system as shown in FIG. 5, formulation and activation of a task is performed (step 101) and an initial value is set to be used when the task is restarted (step 102) such as when a counter is set to a count value A. Once the initial value is set, the system enters a standby mode in which it waits for the occurrence of events A, B and C (steps 103, 104, 105). If the event A occurs (step 103), a corresponding process A is executed (step 106) and then enters a standby mode for waiting for the occurrence of the next event (steps 103 to 105). In like manner, when the event B takes places (step 104), a corresponding process B is executed (step 107) and then waits for the next event. When the event C occurs, a corresponding process is execute and then enters a standby mode for the next event. Since it is generally recognized that a large overhead is required if the occurrence of an event is a trigger to generate and process a task. The system of FIG. 5 is intended to avoid this problem and to improve system's operating efficiency by generating a task first before an event occurs.

However, if a program is patched to remove anomaly or restored by using an undo process in such a prior art system, the process following step 103 forms an endless loop. Once the system enters the loop, it never returns to the starting point of step 102. Therefore, in the prior art techniques as disclosed in the aforesaid Japanese patent publications, if an attempt were made, when the system has entered the loop, to modify reopen-time initial setting functions online by applying a patch, the system would never perform step 102 and hence the functions are not called. In order to reflect modified contents on a task by the application of a patch, it is necessary to restart the task to repeat step 102. However, the restarting of a task usually requires peripheral devices to be rebooted.

In a multi-task environment, the restarting of a task would involve restarting of the whole system. In a multi-task system as disclosed in Japanese Patent Publications 8-263279 and 9-62500, when a control program is repaired while an online task is being processed by parallel-running processors, provision is made to allow only one processor to perform an interrupt routine while others are set in a standby state. During the interrupt routine, the processor loads a patch file stored in a peripheral device into a particular area of its main memory and applies its patch to the control program. When the repair is complete, all the other processors are freed from the standby state. While a task to be patched can be restarted independently of other tasks, the whole system must be restarted if one of the parallel-running processors is executing a number of tasks at the same time.

### SUMMARY OF THE INVENTION

It is therefore an object of the present invention to provide a patch processing system and method for a multi-task system that eliminates the need to restart the system.

According to a first aspect of the present invention, there is provided a patch processing system for a multi-task system wherein a plurality of application tasks are operating in parallel. The system comprises exclusion means for performing an exclusive control over the application tasks so that one of the application tasks to be patched (target application task) is prevented from being accessed from other application tasks, stopping means for stopping the operation of the target application task, patch application means for applying a patch to the target application task when the operation of the target application task is stopped, restarting means for restarting the target application task when the patch is applied to the target application task, and release means for removing the exclusive control from the target application tasks after the target application task is restarted.

According to a second aspect, the present invention provides a multi-task computer system comprising a memory, a storage device storing a patch file structured so that first and second executable programs are attached to the patch file when the patch file is read out from the storage device onto the memory, and a control system for reading the patch file from the storage device and copying the first and second programs to the memory. The control system performs an exclusive control over a plurality of parallel-running application tasks so that one of the application tasks is prevented from being accessed from other application tasks, stops the operation of the target application task if the first executable program is stored in the memory, applies a patch to the target application task, restarts the target application task if the second executable program is stored in the memory, and removes the exclusive control after the target application task is restarted.

According to a third aspect, the present invention provides a method of applying a patch to application tasks which are operating in parallel in a multi-task system, comprising performing an exclusive control over the application tasks so that one of the application tasks, or target application task, is prevented from being accessed from other application tasks, stopping the operation of the target application task, applying a patch to the target application task, restarting the target application task when the patch is applied to the target application task, and removing the exclusive control from the application tasks.

According to a further aspect, the present invention provides a method of applying a patch to application tasks which are operating in parallel in a multi-task system by using a memory and a storage device storing a patch file structured so that first and second programs are attached to the patch file when the patch file is read out from the storage device to the memory. The method comprises performing an exclusive control over the application tasks so that one of the application tasks, or target application task, is prevented from being accessed from other application tasks, stopping the operation of the target application task if the first program is stored in the memory, applying a patch to the target application task, restarting the target application task if the second program is stored in the memory, and removing the exclusive control from the application tasks after the target application task is restarted. In addition, the patch file is further structured so that third and fourth executable programs are attached to the patch file when the patch file is read from the storage device. The method further comprises performing an exclusive control over the application tasks so that the patched application task is prevented from being accessed from other application tasks, stopping the operation of the patched application task if the third executable program is detected, performing an undo process on the patched application task, restarting the undone application task if the fourth executable program is detected, and removing the exclusive control from the application tasks.

### BRIEF DESCRIPTION OF THE DRAWIGNS

The present invention will be described in detail further with reference to the following drawings, in which:

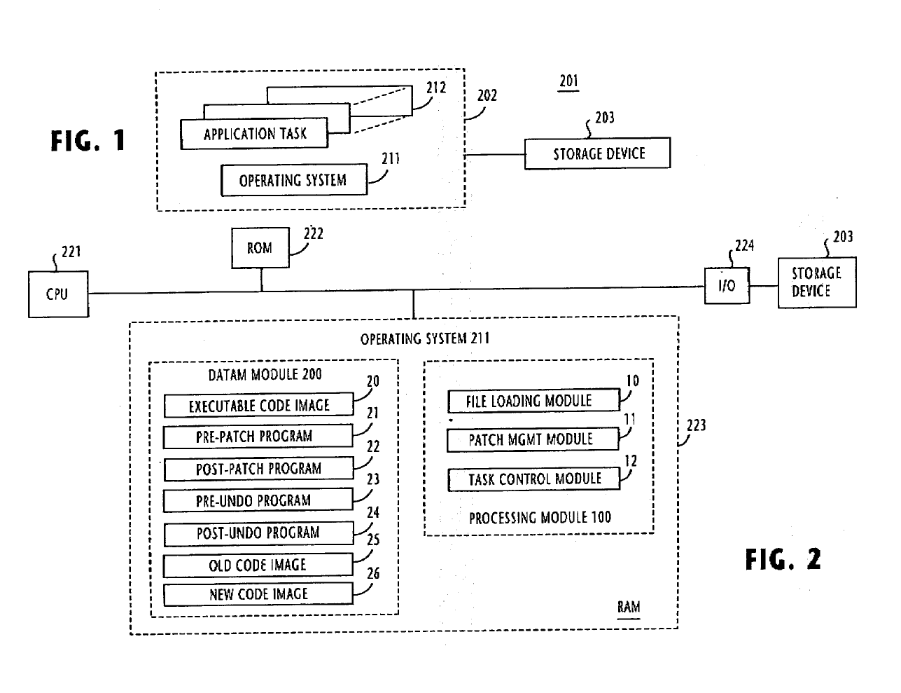

FIG. 1 is a block diagram of a multi-task computer system of the present invention;

FIG. 2 is a block diagram of the control system of FIG. 1;

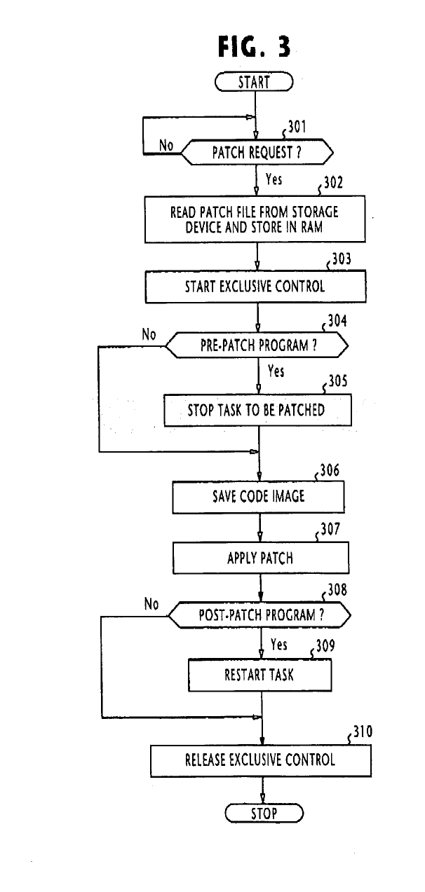

FIG. 3 is a flowchart of the operation of the system when a patch is applied to an application task;

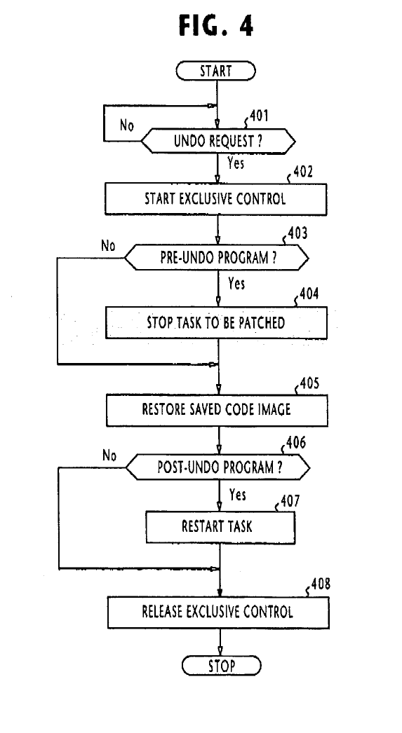

FIG. 4 is a flowchart of the operation of the system when an undo process is performed; and

FIG. 5 is a flowchart of a prior art task system.

### DETAILED DESCRIPTION

Referring to FIG. 1, there is shown a patch processing system 201 according to the present invention. The system is comprised of a control system 202 and an auxiliary memory (a disk drive) 203. Auxiliary memory 203 stores the program of an operating system and resident tasks. In the auxiliary memory 203, patch data is also stored. Control system 202 operates according to an operating system 211 loaded from the memory 263 and a number of application tasks 212 that operate under the operating system 211. Operating system 211 performs file loading for loading patch data from the external storage 203, and has a task control function with which it performs start-stop control on the application tasks. Further, the operating system has a patch management function to apply a patch to modify a program.

As shown in detail in FIG. 2, the control system 202 comprises a CPU 221, a read-only memory 222 for storing predetermined program and fixed data, and a random access memory 223. The operating system, stored on the RAM 223, is broadly divided into a processing module 100 and a data module 200. The processing module 100 includes a file loading module 10, a patch management module 11 and a task control module 12. The data module 200 is a storage area defined in the RAM 223. The data module 200 is divided into a plurality of data storage areas for storing an execution code image (an application task to be patched) 20, a pre-patch program 21, a post-patch program 22, a pre-undo program 23, a post-undo program 24, an old code image 25 and a new code image 26. The data module 200 is essentially a work area of the processing module 100. Via the input/output device 224, the CPU 221, ROM 222 and RAM 223 are connected to the external storage device 203.

The patch processing system of the present invention operates according to flowcharts shown in FIGS. 3 and 4.

When a patch is applied to a program to be patched, the system operates according to the flowchart of FIG. 3. It is assumed that resident application tasks 212 are operating in parallel fashion and that a patch is applied to one of the application tasks 212, which will be called hereinafter a target application task. When a patch request is generated for the target application task (step 301), the file loading module 10 reads a patch file from the external storage device 203 via the input/output device 224 and stores this file in the data area 26, where it is deployed as a new code image (step 302). The patch file loaded from the external storage 203 is a file system that is structured so that other programs can be attached. These programs include a pre-patch program, a post-patch program, a pre-undo program, and a post-undo program, and when these programs are attached, they are stored in the data storage areas 21, 22, 23 and 24 as described above.

At step 303, the patch management module 11 starts an exclusive control over application tasks so that the target application task is prevented from being accessed from other tasks when a patch is being applied to the target task.

Patch management module 11 checks to see if a pre-patch program is stored in the data area 21 (step 304). If the decision is affirmative at step 304, the pre-patch program is executed at step 305. When the pre-patch program is started, the patch management module 11 applies a request to the task control module 12 to remove an application task to be patched. In response, the task control module 12 removes the target application task which is requested.

Next, the patch management module 11 saves the execution code image by transferring it from the data area 20 to the old code image area 25 in preparation for a possible patch undo operation (step 306). If no pre-patch program is detected at step 304, the saving operation is immediately performed following the execution of step 304.

At step 307, the patch management module 11 now performs a patch by deploying the patch file stored at step 302 in the new code image area 26 onto the corresponding memory locations of the execution code image area 20 where the application task to be patched has previously been stored.

At step 308, the patch management module 11 checks to see if a post-patch program is stored in the data area 22. If the decision is affirmative at step 308, the post-patch program is executed at step 309. When the post-patch program is started, the patch management module 11 applies a request to the task control module 12 to restart the patched application task. In response, the task control module 12 restarts the requested application task. As a result, if the patch file that is applied at step 307 is one that requires the modification of reopen-tine initial setting function, such a modification can be effected. Step 309 is skipped when the decision at step 308 indicates that no post-patch program is stored in the data area 22.

Finally, at step 310, the patch management module 11 releases the exclusive control which was started at step 303, allowing other application tasks to access the target application task. It is seen that a patch can be applied without restarting application tasks other than the target application task when all application tasks are operating under the same operating system 211.

When an undo process is required, the patch processing system of this invention operates according to the flowchart of FIG. 4. The undo process is one which restores the contents of execution code image area 20 to the stage they were in just before the patch command was given. The undo process is initiated in response to an undo request entered through a keyboard, not shown. When the control system 202 receives an undo request (step 401), the patch management module 11 starts an exclusive control over application tasks so that the application task to be restored is prevented from being accessed from other tasks when an undo process is performed (step 402).

Patch management module 11 checks to see if a pre-undo program is stored in the data area 23 (step 403). If the decision is affirmative at step 403, the pre-undo program is executed at step 404. When the pre-undo program is started, the patch management module 11 applies a request to the task control module 12 to remove an application task to be restored. In response, the task control module 12 removes the target application task which is requested.

Next, the patch management module 11 transfers the saved memory contents from the old code image area 25 to the execution code image area 20 (step 405). If no pre-undo program is stored in the data area 23, the undo process is performed at step 405 immediately following the execution of step 403. The memory contents of the execution code image area 20 are now restored to the stage where they were in just before the patch was performed. Patch management module 11 checks to see if a post-undo program is stored in the data area 24 (step 406). If the decision is affirmative at step 406, the post-undo program is executed at step 407. When the post-undo program is started, the patch management module 11 applies a request to the task control module 12 to restart the restored application task. In response, the task control module 12 restarts the requested application task. As a result, if the reopen-time initial setting function has been modified by the patch application and undo process, the modified value can be restored to the original value. Assume that a counter has a value A, which is modified to B at step 307, and the counter is restarted at step 309 with the value B as an initial value. The undo process at step 405 restores the counter value to A and the restored value A is reflected as an initial value when the application task is restarted at step 407.

Step 407 is not performed if the decision at step 406 indicates that a post-undo program is not stored in the data area 24. For example, in cases where the initial setting value is not modified, it is not necessary to restart the restored application task. In such instances, the post-undo execution program is not stored and step 407 can be skipped.

Finally, at step 408, the patch management module 11 releases the exclusive control which was started at step 402, allowing other application tasks to access the restored application task. It is seen that an undo process can be performed to restore a patched application without restarting all other application tasks when all application tasks are operating under the same operating system 211.

As described above, since the present invention enables a patch file to be attached with a pre-patch program and a post-patch program, it is possible to stop and restart an application task even if a patch is of the type that requires the task to be restarted. The need to restart a whole system is eliminated. The same advantages can be obtained when the patched application task is undone.

In a preferred embodiment, the variables of a target application task may be saved in memory before a patch or undo is performed and the stored variables are recovered after the patch or undo is performed. This allows data to be smoothly handed over between different stages of an application before and after a patch or an undo is performed.

What is claimed is:

1. A patch processing system for a multi-task system wherein a plurality of application tasks are operating in parallel, comprising:
exclusion means for performing an exclusive control over said application tasks so that one of said application tasks is prevented from being accessed from other application tasks;
stopping means for stopping the operation of said one application task;
patch application means for applying a patch to said one application task when the operation of said one application task is stopped;
restarting means for restarting said one application task when said patch is applied to said one application task; and
release means for removing said exclusive control from said application tasks after said one application task is restarted.

2. A patch processing system for a multi-task system wherein a plurality of application tasks are operating in parallel, wherein one of said application tasks is patched, comprising:
exclusion means for performing an exclusive control over said application tasks so that said patched application task is prevented from being accessed from other application tasks;
stopping means for stopping the operation of said patched application task;
undo means for performing an undo process on said patched application task when the operation of said patched application task is stopped;
restarting means for restarting the undone application task when said undo process is performed on said patched application task; and
release means for removing said exclusive control from said application tasks after said undone application task is restarted.

3. A patch processing system for a multi-task system wherein a plurality of application tasks are operating in parallel, said patch processing system having first and second modes of operation, comprising:
exclusion means for performing an exclusive control over said application tasks so that one of said application tasks is prevented from being accessed from other application tasks, when said system is operating in either of said first and second modes;
stopping means for stopping the operation of said one application task, when said system is operating in either of said first and second modes;
patch application means for applying a patch to said one application task when the operation of said one application task is stopped, when said system is operating in said first mode;
undo means for performing an undo process on said patched application task when the operation of said patched application task is stopped, when said system is operating in said second mode;
restarting means for restarting said one application task when said patch is applied to said one application task when said system is operating in either of said first and second modes; and
release means for removing said exclusive control from said application tasks after said one application task is restarted when said system is operating in either of said first and second modes.

4. A multi-task computer system comprising:
a memory;
a storage device storing a patch file structured so that first and second executable programs are attached to said patch file when the patch file is read out from said storage device to said memory; and
a control system for reading said patch file from said storage device and copying said first and second programs to said memory;
said control system performing an exclusive control over a plurality of parallel-running application tasks so that one of the application tasks is prevented from being accessed from other application tasks, stopping the operation of said one application task if said first program is stored in said memory, applying a patch to said one application task, restarting said one application task if said second program is stored in said memory, and removing said exclusive control from said application tasks after said one application task is restarted.

5. A method of applying a patch to application tasks which are operating in parallel in a multi-task system, comprising:
performing an exclusive control over said application tasks so that one of said application tasks is prevented from being accessed from other application tasks;
stopping the operation of said one application task;
applying a patch to said one application task;
restarting said one application task when said patch is applied to said one application task; and
removing said exclusive control from said application tasks.

6. The method of claim 4, further comprising;
performing an exclusive control over said application tasks so that said patched application task is prevented from being accessed from other application tasks;
stopping the operation of said patched application task;
performing an undo process on said patched application task;
restarting the undone application task; and
removing said exclusive control from said application tasks.

7. A method of applying a patch to application tasks which are operating in parallel in a multi-task system by using a memory and a storage device storing a patch file structured so that first and second executable programs are attached to said patch file when the patch file is read out from said storage device, comprising:
performing an exclusive control over said application tasks so that one of said application tasks is prevented from being accessed from other application tasks;
stopping the operation of said one application task if said first executable program is stored in said memory;
applying a patch to said one application task;
restarting said one application task if said second executable program is stored in said memory; and
removing said exclusive control from said application tasks after said one application task is restarted.

8. The method of claim 7, wherein said patch file is structured so that third and fourth executable programs are attached to said patch file when the patch file is read out from said storage device, further comprising:
performing an exclusive control over said application tasks so that said patched application task is prevented from being accessed from other application tasks;
stopping the operation of said patched application task if said third executable program is detected;
performing an undo process on said patched application task;
restarting the undone application task if the fourth executable program is detected; and
removing said exclusive control from said application tasks.
